(19) United States
(12) Patent Application Publication
(10) Pub. No.: US 2005/0108708 A1
(43) Pub. Date: May 19, 2005

(54) Method to install software via a network and network apparatus thereof

(75) Inventor: Jae-seong Im, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/889,016

(22) Filed: Jul. 13, 2004

(30) Foreign Application Priority Data
Nov. 19, 2003 (KR) 10-2003-82224

(51) Int. Cl. G06F 9/445

(52) U.S. Cl. 717/178

(57) ABSTRACT

A network apparatus to install software via a network, where the network apparatus includes a software storage unit, a software retrieval unit, and a software installation unit. The software storage unit stores at least one software program. When information of a hardware is received via the network, the software retrieval unit retrieves the software executable on the hardware from the software storage unit based on the hardware information, and sends the list of the retrieved software to the hardware over the network. When at least one software program is selected from among the retrieved list of the software, the software installation unit extracts the selected software from the software storage unit, downloads the extracted software to the hardware, and automatically installs the downloaded software on the hardware.

### CROSS-REFERENCE TO RELATED APPLICATION

This application claims the priority of Korean Patent Application No.10-2003-82224 filed on Nov. 19, 2003, in the Korean Intellectual Property Office, the disclosure of which is incorporated herein in its entirety by reference.

### BACKGROUND OF THE INVENTION

1. Field of the Invention

The present invention relates to software installation via a network and, more particularly, to a method to automatically install software on a user computer via a network while the software is downloaded in real-time.

2. Description of the Related Art

Generally, when users purchase computers, the users must buy not only hardware but also software to be installed and operated on the hardware. The software includes various kinds of software, such as operating systems (OSs), device drivers for various kinds of devices, application programs, networking software used to implement networking, etc.

FIG. 1 illustrates the most common approach using which users are able to purchase computers.

First, a computer manufacturer (not shown) predicts the current demand for computers (100), and determines specifications of hardware and software constituting the computer through various analyses (110). Then, the hardware and the software are manufactured in accordance with the determined specifications (120 and 130), and installation of the software on the hardware completes each model computer.

This approach is referred to as a “Build to Plan (BTP)” system. More specifically, a designated number of computers are manufactured in accordance with a predetermined specification, and the manufactured computers are sold to purchasers.

There are some drawbacks to selling computers according to the BTP system. For instance, the computer purchasers are obliged to buy computers having preinstalled software that is unnecessary. Thus, the purchasers are limited to computers having unwanted specifications. Consequently, it is impossible to satisfy various requirements of the purchasers. For this reason, it has been proposed that purchasers should be allowed to buy a computer having software with desired specifications.

FIG. 2 illustrates an improvement of the approach shown in FIG. 1, which allows users to buy a computer having the users' own pre-selected desired software installed.

Accordingly, a computer manufacturer (not shown) predicts the current demand for computers (200), and determines the specifications of hardware and software constituting the computer through various analyses (210). Then, the hardware is manufactured in accordance with the determined specifications (220). However, the users are allowed to select from hardware having various specifications (230). Accordingly, the users are allowed to select the hardware having the users' desired specifications, either from an offline computer seller or from an online computer seller.

In the case of the software for the computer, the users obtain access to the online computer seller over the network, and then select desired software (240). Here, the users can select various kinds of software including operating systems, device drivers, application programs, etc.

After at least one software program is selected, the selected software is installed on the pre-selected hardware, and thereby the computer is completed as one model. This approach is called a “Configure-to-Order (CTO)” system. Specifically, images of an existing master installation are individually modified, and computers are manufactured according to specifications that meet requirements of the users. For example, DELL® Inc. of U.S.A. employs the CTO system to sell computers.

The CTO system may be relatively successful in satisfying the needs of users when the users initially buy a computer. However, when the users want to upgrade the operating system or install a higher version of an application program, the users have to put up with the inconvenience of directly finding and installing the software compatible with the hardware the users possess. In this case, users, especially those with minimal knowledge of computers and/or software installation, have to overcome considerable difficulties.

Accordingly, there is a necessity for a system and method, which not only enable users to select the software according to the users' desired specifications at the time of purchase, but also enable users with minimal knowledge of computers to easily install and upgrade software when software needs to be installed and upgraded after the time of purchase.

### SUMMARY OF THE INVENTION

To solve the above-indicated and/or other problems, the present invention provides a method to install software via a network and a network apparatus used in the method, which is designed to enable a user who bought a computer to easily install new software on the computer and easily upgrade old software subsequent to the time of purchase.

According to an aspect of the present invention, a network apparatus comprising: a software storage unit, a software retrieval unit, and a software installation unit is provided. The software storage unit stores at least one software program. The software retrieval unit, upon receipt of information on hardware via a network, retrieves software executable on the hardware from the software storage unit based on the information, and sends a list of retrieved software to the hardware over the network. When at least one software program is selected from the retrieved list of the software, the software installation unit extracts the selected software from the software storage unit, downloads the extracted software to the hardware, and automatically installs the downloaded software on the hardware. According to an aspect of the present invention, the hardware is provided with an operating system that provides a network function and allows other software to be installed. According to an aspect of the present invention, the hardware is provided with an operating system that provides a network function and allows other software including previously installed software to be installed. Further, according to an aspect of the present invention, the information is identification information of the hardware.

In order to achieve the object, according to another aspect of the present invention, there is provided a method to install software by use of a network comprising: sending hardware information to a server; receiving a list of the executable software on the hardware from the server via the hardware, where the list of the software being retrieved using the hardware information; providing the received list of the software to a user; enabling the user to select software to be installed on the hardware from among the provided list of the software; and downloading the selected software from the server and automatically installing the downloaded software on the hardware. According to an aspect of the present invention, the hardware is provided with an operating system that provides a network function and allows other software to be installed. According to another aspect of the present invention, the hardware is provided with an operating system having a network function and that allows other software including previously installed software be installed. Further, the hardware information is identification information of the hardware.

According to yet another aspect of the present invention, there is provided a method to install software by use of a network. The method comprises: receiving hardware information from the hardware; retrieving a list of the software executable on the hardware based on the received information; sending the retrieved list of software to the hardware; and downloading software selected by a user from the list of the software sent and automatically installing the downloaded software on the hardware. According to an aspect of the present invention, the hardware is provided with an operating system having a network function, and allows other software to be installed. And according to another aspect of the present invention, the hardware is provided with an operating system that provides network function and allows other software including previously/preinstalled software to be installed. According to an aspect of the present invention, the hardware information is identification information of the hardware.

### BRIEF DESCRIPTION OF THE DRAWINGS

The above and/or other aspects, and advantages of the invention will become apparent and more readily appreciated from the following description of the embodiments, taken in conjunction with the accompanying drawings of which:

FIG. 1 illustrates a common approach to allow users to purchase computers;

FIG. 2 illustrates an improvement of the approach shown in FIG. 1 to allow users to buy computers having pre-selected software installed;

FIG. 3 shows a block diagram of a client system to install software in accordance with an aspect of the present invention;

FIG. 4 shows a block diagram of a server system, which provides software in accordance with an aspect of the present invention; and

FIG. 5 is a flow chart to show a method to install software using a network in accordance with an aspect of the present invention.

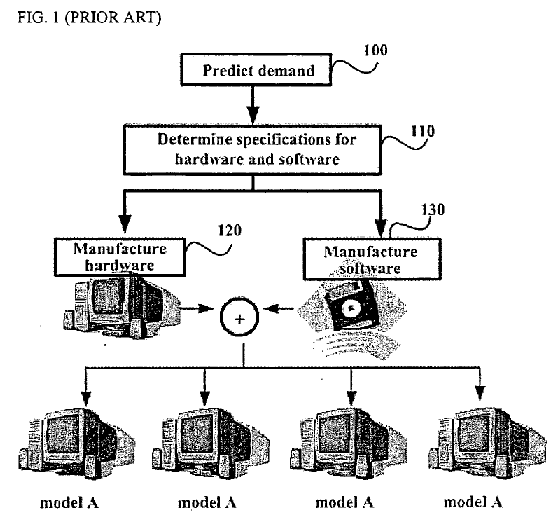

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

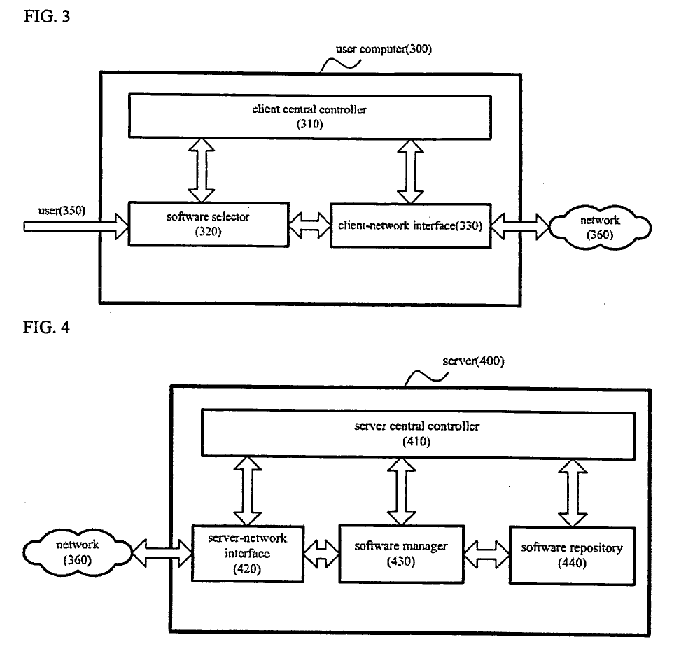

FIG. 3 shows a block diagram of a client system intended to install software in accordance with an aspect of the present invention.

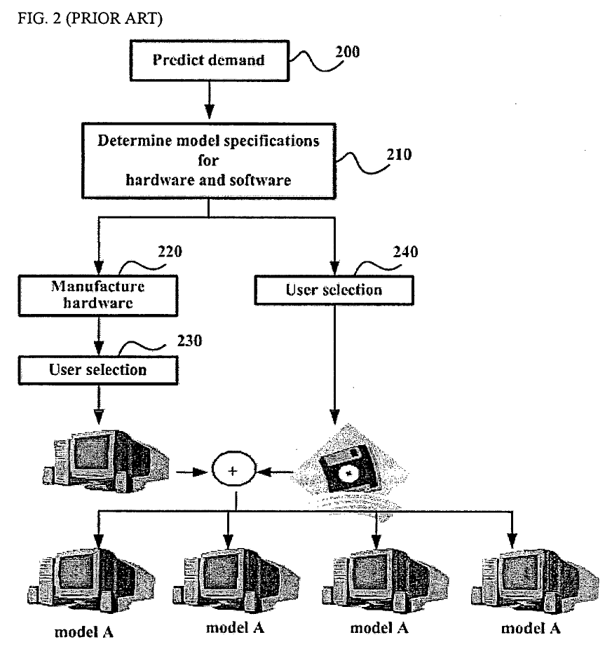

According to an aspect of the present invention, the client system is a user computer 300. The user computer 300 includes only an essential operating system, which provides a pre-installation environment to perform booting, networking, and software installation via a network 360 in order to install software on a hard disk with no data when a user 350 buys the computer 300. As an example of an essential operating system, there is “WinPE,” an essential Win32 operating system, which provides limited services written on the kernel of the Windows XP professional operating system. Other operating systems include “FirstWare”, “DOS”, etc. In accordance with another aspect of the present invention, the user computer 300 is purchased by the user 350 according to the “Configure-to-Order” system shown in FIG. 2.

According to an aspect of the present invention, the user computer 300 includes a software selector 320 to select software, which a user intends to install, a client-network interface 330 to send/ receive software installation information between a server 400 that provides the selected software and the user computer 300, and a client central controller 310 to control operations of the software selector 320 and the client-network interface 330.

Hereinafter, description of operations between components of the user computer 300 is provided.

When the user 350 starts the user computer 300 to install new software or update an old software, the client central controller 310 sends hardware information of the user computer 300 to the server 400 that provides the software via the client-network interface 330. Here, the hardware information includes identification information on the serial or model number of the user computer 300 and/or information on the specification for each hardware component constituting the user computer 300. This information is stored in the server 400. When the user computer 300 receives a list of the software, which are executable on the user computer 300, and are retrieved using the hardware information from the server 400, the received list of the software is provided to the user 350 via the software selector 320. Accordingly, the software selector 320 provides the received list of the software to the user 350 in a simple graphic user interface or in a text user interface.

When the user 350 selects a list of the software intended for installation using the software selector 320, the list of the selected software is sent to the server 400. The server 400 downloads the selected software to the user computer 300 and automatically installs the downloaded software on the user computer 300. In other words, from the viewpoint of the user 350, the user observes automatic installation of desired software on the users' computer with the assistance of the server 400, even when the user only knows the name of desired software without any detailed information of the computer. The client central controller 310 implements command control or event handling between the software selector 320 and the client-network interface 330.

FIG. 4 shows a block diagram of a server system that provides software in accordance with an aspect of the present invention.

As shown in FIG. 4, the server system is the server 400. According to an aspect of the present invention, the server 400 is established and managed either by a computer seller (not shown) who sold the user computer 300 or by any nominated subcontractor (not shown) subcontracting with the computer seller.

According to an aspect of the present invention, the server 400 includes a software repository 440, a server-network interface 420, a software manager 430, and a server central controller 410. The software repository 440 stores software capable of being installed on desired hardware connected with the network 360. The server-network interface 420 provides an interface to allow receipt of hardware information of the user computer 300 on which software is intended to be installed via the network 360, and to automatically install the software on the user computer 300 in real-time via the network 360. The software manager 430 retrieves corresponding software from the software repository 440 using the hardware information of the user computer 300, which is received from the server-network interface 420, and sends the retrieved list of the software to the server-network interface 420. The software manager 430 also extracts the software selected by the user 350 from the software repository 440 and automatically installs the extracted software on the user computer 300. The server central controller 410 controls operations of the server-network interface 420, the software manager 430, and the software repository 440.

Hereinafter, description of operations between components of the server is provided.

When the server-network interface 420 receives hardware information of the user computer from the user computer 300 connected with the network 360, the server-network interface 420 sends the hardware information to the software manager 430. According to an aspect of the present invention, the hardware information includes identification information including the serial or model number of the user computer 300 and/or information on the specification for each hardware component constituting the user computer 300. According to an aspect of the present invention, the hardware information is pre-stored in the server 400.

The software manager 430 retrieves a list of software executable on the user computer 300 from the software repository 440 based on the hardware information, and then sends the retrieved list of the software to the user computer 300 via the server-network interface 420.

The user 350 selects software to be installed on the user computer 300 from the list of the software supplied from the server 400, and the information on the selected software is sent to the server 400 via the network 360.

Then, the software manager 430 of the server 400 extracts software corresponding to the received information from the software repository 440, and sends the extracted software to the user computer 300. According to an aspect of the present invention, the software to be sent is automatically installed on the user computer 300 at the same time. Meanwhile, the server central controller 410 implements command control or event handling among the server-network interface 420, the software manager 430, and the software repository 440.

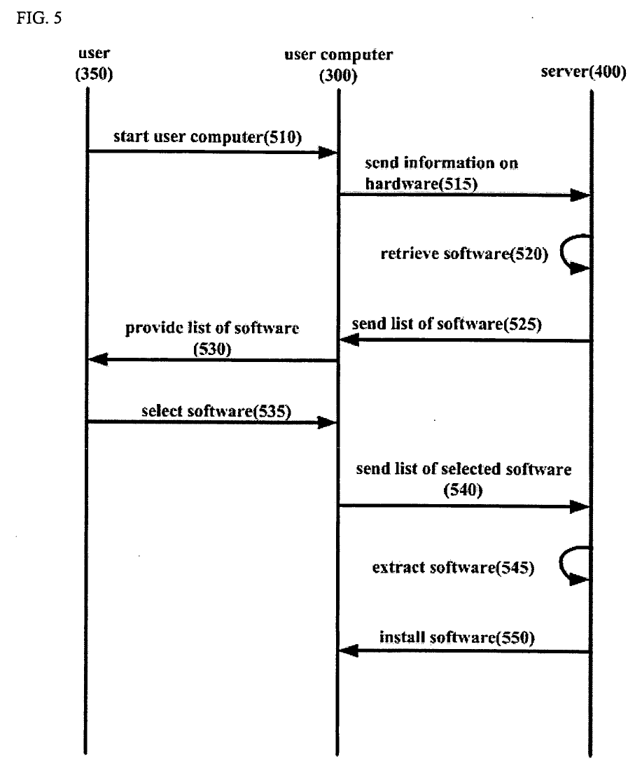

FIG. 5 is a sequence diagram to show a method to install software via a network in accordance with an aspect of the present invention.

The user 350 starts the user computer 300 to install new software or update existing software (510). The user computer 300 sends hardware information of the user computer 300 to the server 400 (515). In this case, the hardware information includes identification information including the serial or model number of the user computer 300 and/or information on the specification for each hardware component constituting the user computer 300. According to an aspect of the present invention, the identification information is pre-stored in the server 400.

The server 400 retrieves a list of the software executable on the user computer 300 using the hardware information (520), and sends the retrieved list of the software to the user computer 300 (525).

The user computer 300 provides the user 350 with the list of the software received from the server 400 (530), and the user 350 selects software to be installed on the user computer 300 from the provided list of the software (535). At this time, the user computer 300 provides the received list of the software to the user 350 either in a simple graphic user interface or in a text user interface.

The user computer 300 sends the list of the software selected by the user 350 to the server 400 (540). The server 400 extracts the selected software (545), and automatically installs the extracted software on the user computer 300 (550) while downloading the extracted software to the user computer 300.

By using the network apparatus and the method to install software via a network according to an aspect of the present invention, even inexperienced users without knowledge of software installation operation easily install and upgrade software compatible with their own hardware, and recover damaged software. In addition, it is possible to enhance product reliability when a server that provides the software is established and managed by a computer manufacturer.

Although a few embodiments of the present invention have been shown and described, it would be appreciated by those skilled in the art that changes may be made to the embodiments without departing from the principles and spirit of the invention, the scope of which is defined in the accompanying claims and their equivalents.

1. A method to install software via a network, comprising:
sending hardware information to a server;
receiving a list of executable software from the server, the list of software being retrieved based on the hardware information;
providing the received list of software to a user;
enabling the user to select software to be installed from the list of executable software; and
downloading the selected software to be installed from thr server and automatically installing the downloaded software on the hardware.

2. The method according to claim 1, wherein the hardware is provided with an operating system that provides a network function, and allows other software including

3. The method according to claim 1, wherein the hardwre is provided with an operating system that provided a network function, and allows other software including previousky installed software to be installed.

4. The method according to claim 1, wherein the hardware information is identification information of the hardware.

5. A method to install software by use of a networ, comprising:
receiving hardware information from the hardware;
retrieving a list of executable software based on the recieved information;
sending the retrieved list of software to the hardware; and
downloading software selected by a user from the sent list of softwar, and automaticallyinstalling the downloaded software on the hardware.

6. The method according to claim 5, wherein the hardware is provided with an operating system that provides a network function, and allows other software to be installed.

7. The method according to claim 5, wherein the hardware is provided with an operating system that provides a network function, and allows other software including previously installed software to be installed.

8. The method according to claim 5, wherein the hardware information is identification information of the hardware.

9. A network apparatus, comprising:
a software storage unit to store at least one software;
a software retrieval unit to retrieve executable software from the software storage unit based on hardware information received via a network, and to send a list of the retrieved software to the hardware over the network; and
a software installation unit to extract selected software from the software storage unit when at least one software is selected from the retrieved list of software, and to download the extracted software to the hardware and automatically install the downloaded software on the hardware.

10. The network apparatus according to claim 9, wherein the hardware is provided with an operating system that provides a network function, and allows other software to be installed.

11. The network apparatus according to claim 9, wherein the hardware is provided with an operating system that provides a network function, and allows other software including previously installed software to be installed.

12. The network apparatus according to claim 9, wherein the hardware information is identification information of the hardware.

13. The network apparatus according to claim 9, further comprising:
a software selector using which a user selects software to be installed from the retrieved list of software.

14. The network apparatus according to claim 12, wherein the hardware information includes hardware specification data having model number and/or serial number of the hardware.

15. The network apparatus according to claim 9, further comprising:
a server-network interface to provide interface to allow receipt of the hardware information; and
a software manager to extract corresponding software from the software storage unit based on the hardware information received via a network.

16. A method to install software, comprising:
sending hardware specification data to a server;
receiving a list of executable software from the server based on the hardware specification data;
selecting software to be installed from the list of executable software; and
downloading the selected software from the server and automatically installing the downloaded software.

17. The method according to claim 16, further comprising:
updating the downloaded software based on the hardware specification data.

18. A method to install software via a network, comprising:
receiving a list of executable software from a server based on hardware information of a computer system connected with the network, where the hardware information is identification information of the hardware of the computer system; and
downloading selected software from the server and automatically installing the downloaded software to the hardware of the computer system.

19. The method according to claim 18, wherein the hardware connected with the network includes an operating system that provides pre-installation environment to allow software installation via the network.

20. The method according to claim 19, further comprising:
automatically updating the downloaded software based on the hardware information of the computer system.

21. The method according to claim 18, wherein hardware information of the computer system is pre-stored in the server.

22. The method according to claim 21, further comprising:
receiving a request from a user of the computer system to download software, wherein the list of executable software is sent to the user based on the request.

23. The method according to claim 18, wherein the downloading and installation of the selected software are performed simultaneously.

24. The method according to claim 18, wherein the hardware information of the computer system includes hardware specification data having model number and/or serial number of the hardware of the computer system.
